(19) United States
(12) Patent Application Publication
(10) Pub. No.: US 2014/0289741 A1
(43) Pub. Date: Sep. 25, 2014

(54) COOPERATION METHOD, IMAGE PROCESSING DEVICE, AND MEDIUM

(71) Applicant: FUJITSU LIMITED, Kawasaki-shi (JP)

(72) Inventors: Junichi Yura, Yokohama (JP); Hideto Kihara, Kawasaki (JP); Takashi Ohno, Kobe (JP)

(73) Assignee: FUJITSU LIMITED, Kawasaki-shi (JP)

(21) Appl. No.: 14/178,865

(22) Filed: Feb. 12, 2014

(30) Foreign Application Priority Data
Mar. 21, 2013 (JP) 2013-058555

(51) Int. Cl. G06F 9/54

(52) U.S. Cl. CPC G06F 9/54
USPC 719/313

(57) ABSTRACT

A cooperation method executed by a computer, the cooperation method includes: extracting, based on a first application that is executed, kind of data being processed by the first application, and history information, at least one second application that was executed next to the first application before; executing processing the data using the at least one second application; evaluating a result of the processing by the at least one second application; and suggesting a second application, among the at least one second application, based on a result of the evaluating.

### CROSS-REFERENCE TO RELATED APPLICATION

This application is based upon and claims the benefit of priority of the prior Japanese Patent Application No. 2013-058555, filed on Mar. 21, 2013, the entire contents of which are incorporated herein by reference.

### FIELD

The embodiment discussed herein is related to inter-application cooperation.

### BACKGROUND

Users can freely add or delete an application in communication terminals such as a smartphone and a tablet terminal. Thus, the number of applications installed in a communication terminal is on the increase.

Such a function is provided that allows various applications to be used in cooperation with one another on the basis of data and processing content. For example, there exists a technique for collecting information on a cooperation source application and a cooperation target application each time an application is executed and displaying a cooperation history. In addition, there exists another technique for automatically determining an application that is capable of accepting data inputted by the user by comparing input/output data items in a cooperation condition that is registered in advance. Furthermore, there exists yet another technique with which, when an application is used, input data and an output result obtained by executing the application are registered manually or automatically in a database, and when another application or an application related to the data being processed is to be presented to the user, the recorded data is displayed along therewith. For example, these techniques are discussed in Japanese Laid-open Patent Publication No. 2004-157676, Japanese Laid-open Patent Publication No. 2010-250386, and Japanese Laid-open Patent Publication No. 2011-113401.

### SUMMARY

According to an aspect of the invention, a cooperation method executed by a computer, the cooperation method includes: extracting, based on a first application that is executed, kind of data being processed by the first application, and history information, at least one second application that was executed next to the first application before; executing processing the data using the at least one second application; evaluating a result of the processing by the at least one second application; and suggesting a second application, among the at least one second application, based on a result of the evaluating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a functional configuration of an information processing device;

FIG. 2 illustrates an example of a hardware configuration that is capable of implementing cooperation processing;

FIG. 3 is a flowchart illustrating an example of pre-execution processing;

FIG. 4 is a flowchart illustrating an example of cooperation application execution processing;

FIG. 5 illustrates an example of inter-application cooperation in an embodiment;

FIG. 6 is a diagram for describing content of pre-execution detection;

FIG. 7 is a flowchart illustrating an example of pre-execution detection processing;

FIGS. 8A and 8B illustrate exemplary data stored in a storage unit;

FIG. 9 is a diagram for describing a method for determining a pre-execution order;

FIG. 10 is a diagram for describing an example of obtaining a candidate application;

FIG. 11 is a flowchart illustrating an example of pre-execution evaluation processing;

FIGS. 12A and 12B illustrate examples of inter-application cooperation information;

FIGS. 13A, 13B, and 13C illustrate a specific example of a pre-execution evaluation;

FIGS. 14A and 14B illustrate another specific example of the pre-execution evaluation;

FIG. 15 illustrates an exemplary screen;

FIGS. 16A and 16B illustrate other exemplary screen; and

FIGS. 17A, 17B, and 17C illustrate other exemplary screen.

### DESCRIPTION OF EMBODIMENT

With the existing techniques described above, there is a possibility that applications are unable to cooperate even when an application is selected since the state of a communication terminal or data to be handled changes dynamically. For example, even when a picture of a bar code is captured by a camera application and the captured image is handed to a bar code application, that application may not be able to recognize the captured image as a valid code. As another example, even when an email text is handed to a print application in order to print the text, the text may not be able to be printed since a printer for printing the text is not found.

In one aspect, a technique disclosed in an embodiment is directed to appropriately carrying out inter-application cooperation.

Hereinafter, an embodiment will be described in detail with reference to the accompanying drawings.

Exemplary Functional Configuration of Information Processing Device

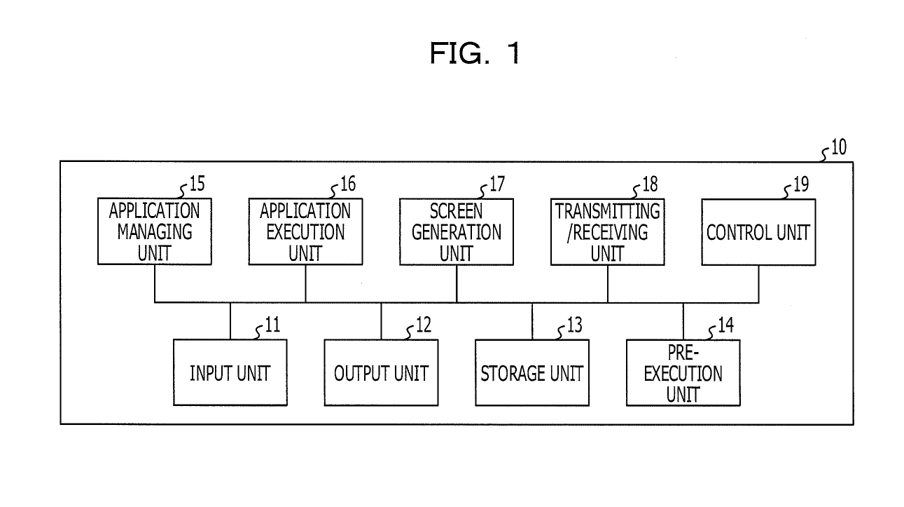

FIG. 1 illustrates an example of a functional configuration of an information processing device. An information processing device 10 illustrated in FIG. 1 includes an input unit 11, an output unit 12, a storage unit 13, a pre-execution unit 14, an application managing unit 15, an application execution unit 16, a screen generation unit 17, a transmitting/receiving unit 18, and a control unit 19.

The input unit 11 accepts various inputs such as the start and the end of various instructions and an input for configuring settings from a user or the like of the information processing device 10. The input unit 11 accepts instructions for carrying out, for example, pre-execution processing, application managing processing, application execution processing, screen generation processing, transmission/reception processing, and so on of the embodiment.

If an instruction indicates, for example, an operation (browsing, editing, and so on) on a single piece of data, the input unit 11 outputs the inputted information to the pre-execution unit 14. Meanwhile, if an instruction indicates, for example, a request for selecting an application or an operation for selecting an application, the input unit 11 outputs the inputted information to the application managing unit 15 and so on.

Information may be inputted to the input unit 11 through, for example, a keyboard, a mouse, a touch panel system that uses a screen, a microphone, or the like.

The output unit 12 outputs content that has been inputted through the input unit 11, content obtained by carrying out processing on the basis of the inputted content, and so on. The output unit 12 includes a display unit such as a display and a monitor if the output unit 12 is configured to output data through, for example, screen display, or the output unit 12 includes an audio output unit such as a speaker if the output unit 12 is configured to output data through a sound. The output unit 12 includes, for example, a tactile presentation unit such as a vibrator that provides a predetermined stimulation to the user. The input unit 11 and the output unit 12 may be integrated into a single entity, as in a touch panel or the like.

The storage unit 13 stores various pieces of information to be used in the embodiment. The storage unit 13 can, for example, store various pieces of information such as various applications installed in the information processing device 10, information for managing the applications, cooperation information, pre-execution content of the applications, generated screen information, and information on history of inputs and outputs or results obtained by executing various processes.

In the embodiment, the storage unit 13 stores the applications themselves, information for managing the applications, and so on. Such information for managing the applications includes, for example, at least one of an application identifier for identifying a cooperation source application (first application), a cooperation target application (second application), or the like, a processing type of cooperation data, a data format, pre-processing data (e.g., time information), the number of instances of cooperation, and so on. The embodiment, however, is not limited to those listed above.

The storage unit 13 stores information on settings for carrying out various processes that can realize the cooperation processing of the embodiment, an execution history of and results from various processes, and so on. Note that information to be stored in the storage unit 13 is not limited to the pieces of information mentioned above.

In addition, various pieces information stored in the storage unit 13 can be read out as desired at a predetermined timing, or various pieces of information can be written into the storage unit 13 as desired at a predetermined timing. The storage unit 13 may be a collection of such various pieces of information as described above and may have a function of a database that is systematically configured so as to enable such pieces of information to be searched through and extracted by using, for example, a keyword or the like. The storage unit 13 is, for example, a hard disk, a memory, or the like, but the embodiment is not limited thereto.

The pre-execution unit 14 includes a pre-execution detecting unit that, for example, predicts, before the user makes a request for inter-application cooperation, that the data currently being displayed or edited would cooperate later on with an application. In addition, the pre-execution unit 14 includes a pre-execution search unit that, for example, searches for a candidate application to be executed subsequently on the basis of the data obtained by the pre-execution detecting unit described above. The pre-execution unit 14 further includes a pre-execution evaluation unit that, for example, evaluates the possibility of cooperation processing by providing data to the candidate application and carrying out predetermined processing in advance.

In response to a selection request operation inputted through the input unit 11, the application managing unit 15, for example, obtains a list of cooperation target applications and pre-processing data from the application managing information stored in the storage unit 13 by using a cooperation source application identifier and cooperation data. The obtained list is then displayed in a screen generated by the screen generation unit 17.

In response to the user inputting a selection operation through the input unit 11 so as to select from a list presented by the application managing unit 15, the application execution unit 16 starts a predetermined application in accordance with the selection operation by, for example, using a function of an operating system (OS) for starting an application. In addition, the application execution unit 16 can store the executed application into the storage unit 13 in the form of cooperation history information.

The screen generation unit 17 generates an input screen through which information on settings for carrying out various processes of the embodiment is inputted, a display screen that displays an execution result of the pre-execution unit 14, a screen for displaying one or a plurality of pieces of application information by the application managing unit 15, and so on. Note that the examples of the screens to be generated are not limited to the above. A generated screen is outputted to the user through, for example, the output unit 12.

The transmitting/receiving unit 18, for example, serves as a communication unit for transmitting and receiving various pieces of information to and from an external device through a communication network such as the Internet and a local area network (LAN). The transmitting/receiving unit 18 can receive various pieces of information stored in the external device or the like and can also transmit a result obtained through the processing of the information processing device 10 to the external device or the like through the communication network.

The control unit 19 integrally controls each of the constituting units of the information processing device 10. The control unit 19, for example, carries out control pertaining to the cooperation processing on the basis of an instruction or the like inputted through the input unit 11 by the user or the like. Here, such control includes, for example, the pre-execution of inter-application cooperation by the pre-execution unit 14 described above, the application management of the application managing unit 15, the application execution of the application execution unit 16, the screen generation of the screen generation unit 17, and so on, but the embodiment is not limited thereto.

Examples of the information processing device 10 described above include, for example, a personal computer (PC), a server, a communication terminal such as a smartphone and a tablet terminal, a portable telephone, and so on, but the embodiment is not limited thereto. In addition, examples of the information processing device 10 can include, for example, a game console, a music player, and so on.

Here, an application in the embodiment may carry out, for example, processes such as printing of an image, a document, or the like, browsing through a web browser, editing of a file by using word processing software or spreadsheet software, emailing function, and starting and stopping a social networking service (SNS). The embodiment, however, is not limited thereto, and various processes to be carried out through a program or the like are also included. In addition, a cooperation source application corresponds to a first application, and a cooperation target application corresponds to a second application that is executed in cooperation with the first application following the execution of the first application.

Exemplary Hardware Configuration of Information Processing Device 10

The cooperation processing of the embodiment can be implemented by, for example, installing an execution program (cooperation processing program), which can cause a computer to implement each function, in the information processing device 10. Here, an exemplary hardware configuration of the computer that can implement the cooperation processing of the embodiment will be described with reference to the drawings.

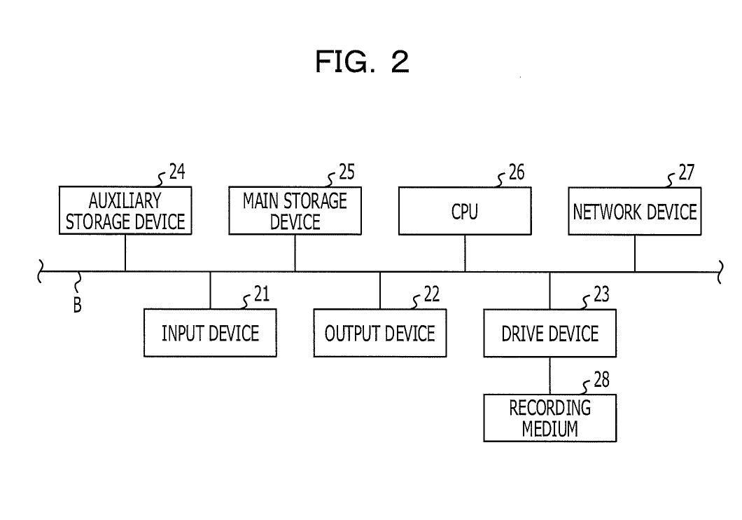

FIG. 2 illustrates an example of the hardware configuration that is capable of implementing the cooperation processing. A computer body illustrated in FIG. 2 includes an input device 21, an output device 22, a drive device 23, an auxiliary storage device 24, a main storage device 25, a central processing unit (CPU) 26, and a network device 27, and these components are interconnected through a system bus B.

The input device 21 includes a pointing device such as a keyboard and a mouse to be operated by the user or the like and an audio input device such as a microphone. The input device 21 accepts inputs such as an instruction from the user or the like for executing a program, various pieces of operation information, and information for starting software or the like.

The output device 22 includes a display that displays various windows, data, and so on to be used for operating the computer body that carries out the processing of the embodiment. The output device 22 displays a history, a result, and so on of executing a program through a control program included in the CPU 26.

Here, the execution program to be installed in the computer body of the embodiment is provided, for example, in the form of a portable recording medium 28 or the like such as a Universal Serial Bus (USB) memory, a CD-ROM, and a DVD. The recording medium 28 in which the program has been recorded can be set in the drive device 23, and the execution program recorded in the recording medium 28 is installed into the auxiliary storage device 24 through the drive device 23 in accordance with a control signal from the CPU 26.

The auxiliary storage device 24, for example, is a storage unit or the like such as a hard disk drive and a solid state drive (SSD). The auxiliary storage device 24 can store the execution program of the embodiment, a control program provided in the computer, and so on in accordance with a control signal from the CPU 26, and data can be inputted into or outputted from the auxiliary storage device 24 as desired. A desired piece of information stored in the auxiliary storage device 24 can be read out or a desired piece of information can be written into the auxiliary storage device 24 in accordance with a control signal or the like from the CPU 26.

The main storage device 25 stores the execution program and so on that have been read out from the auxiliary storage device 24 by the CPU 26. The main storage device 25 is, for example, a read only memory (ROM), a random access memory (RAM), or the like, but the embodiment is not limited thereto. The auxiliary storage device 24 and the main storage device 25 correspond, for example, to the storage unit 13 described above.

The CPU 26 can implement each of the processes by controlling the overall processing of the computer including various calculations and receiving and outputting data from and to each of the hardware configuration components in accordance with the control program of the operating system or the like and the execution program stored in the main storage device 25. Various pieces of information or the like to be used during execution of the programs can be obtained, for example, from the auxiliary storage device 24, and results or the like obtained by executing the programs can also be stored in the auxiliary storage device 24.

The CPU 26, for example, executes a program installed in the auxiliary storage device 24 in accordance with an instruction or the like for the execution of the program obtained from the input device 21 to thus carry out processing, on the main storage device 25, that corresponds to the program. For example, the CPU 26 causes the cooperation processing program to be executed to thus carry out processing such as the pre-execution of inter-application cooperation by the pre-execution unit 14 described above, the application management of the application managing unit 15, the application execution of the application execution unit 16, and the screen generation of the screen generation unit 17. Content of the processing of the CPU 26 is not limited to the above. The content that has been executed by the CPU 26 can be stored in the auxiliary storage device 24 as desired.

The network device 27 connects to a communication network such as the Internet and a LAN in accordance with a control signal from the CPU 26 to thus obtain the execution program, software, setting information, and so on from an external device or the like that is connected to the communication network. In addition, the network device 27 can provide an execution result obtained by executing a program or the execution program itself of the embodiment to the external device or the like.

Such a hardware configuration as described above makes it possible to implement the cooperation processing of the embodiment. In addition, installing the program makes it possible to implement the cooperation processing of the embodiment with ease in a general purpose PC, a communication terminal, or the like.

Note that in the case where the information processing device 10 is a communication terminal such as a smartphone, the information processing device 10 may include, for example, a positioning device that uses the global positioning system (GPS), an acceleration sensor, an angular speed sensor, or the like, in addition to the configuration described above. The network device 27 may include, for example, a communication unit that enables communication through Wi-Fi (registered trademark), Bluetooth (registered trademark), or the like. The network device 27 may include a call unit that enables telephonic communication with a telephone terminal.

Examples of Cooperation Processing

An example of the cooperation processing of the embodiment will now be described with reference to the flowcharts. Note that the cooperation processing is roughly divided into pre-execution processing and cooperation application execution processing, and thus each processing will be described separately.

Pre-Execution Processing

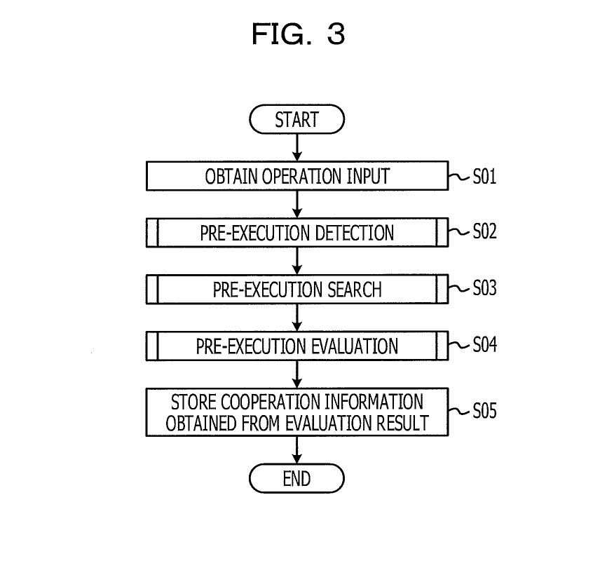

FIG. 3 is a flowchart illustrating an example of the pre-execution processing. In the pre-execution processing illustrated as an example in FIG. 3, the input unit 11 obtains an input indicating an operation on a currently executed application inputted by the user through the information processing device 10 (S01).

Subsequently, the pre-execution unit 14 carries out pre-execution detection processing (S02). The pre-execution unit 14 then carries out pre-execution search processing on the basis of a result obtained through the processing in S02 (S03). In the processing in S03, the pre-execution unit 14, for example, outputs information on a candidate combination of applications or the like indicating, for example, a cooperation source application (first application), a cooperation target application (second application), and target data, on the basis of a target data processing type obtained through the processing in S02, application managing information and cooperation history information obtained from the storage unit 13, and so on.

The pre-execution unit 14 then carries out a pre-execution evaluation on the basis of a result obtained through the processing in S03 (S04). In the processing in S04, the pre-execution unit 14 evaluates a given combination of a cooperation source application and a cooperation target application by actually executing the target data for each candidate application and obtains a processing cost, which is an example of the evaluation result. In addition, the pre-execution unit 14 stores the obtained processing cost in the storage unit 13 as cooperation information (e.g., inter-application cooperation information or the like) that can be obtained from the evaluation result (S05).

Cooperation Application Execution Processing

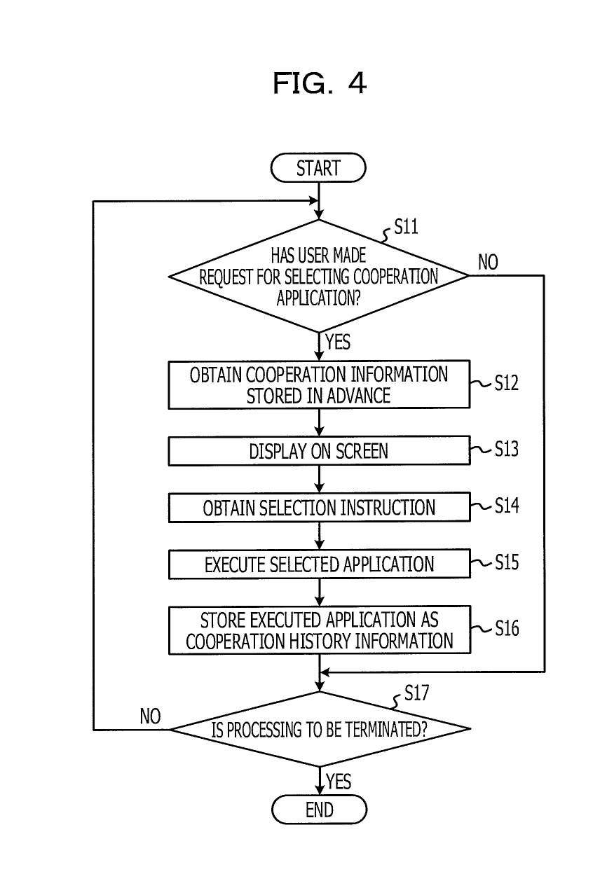

FIG. 4 is a flowchart illustrating an example of cooperation application execution processing. In the cooperation application execution processing illustrated as an example in FIG. 4, the application managing unit 15 determines whether or not the user has made a request for selecting a cooperation application (S11). If the user has made a request for selecting a cooperation application (YES in S11), the application managing unit 15 obtains the cooperation information stored in advance in the storage unit 13 (S12). The cooperation information, for example, corresponds to a list of evaluation results obtained through the pre-execution processing described above, but the embodiment is not limited thereto.

Subsequently, the screen generation unit 17 displays the cooperation information (i.e., list) obtained in S12 on the screen of the output unit 12 as recommended cooperation application information (i.e., candidate application) (S13). In addition, upon the input unit 11 obtaining, from the user, an instruction for selecting an application (S14), the application execution unit 16 executes the selected application (S15). At this time, the application execution unit 16 stores the executed application as the cooperation history information (S16).

Here, the control unit 19 determines whether or not to terminate the cooperation application execution processing (S17). If the processing is not to be terminated (NO in S17), the processing returns to S11. Meanwhile, if the control unit 19 determines to terminate the processing on the basis of an instruction or the like from the user (YES in S17), the control unit 19 terminates the cooperation application execution processing.

### SPECIFIC EXAMPLES

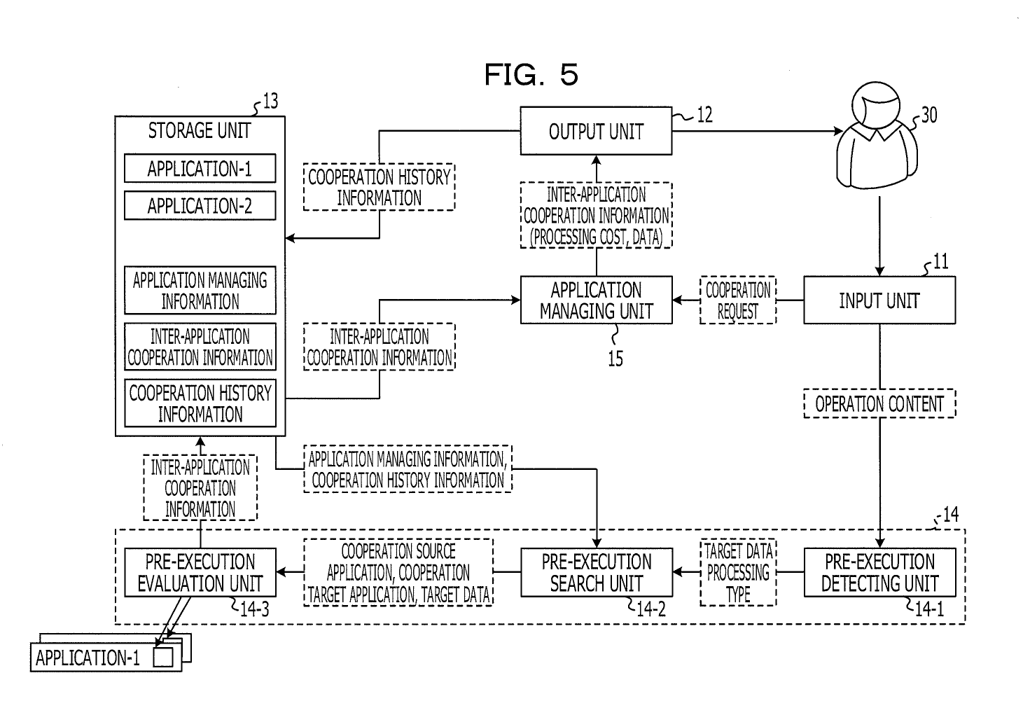

Specific examples of the embodiment will now be described. FIG. 5 illustrates an example of inter-application cooperation of the embodiment. Note that, in the example illustrated in FIG. 5, the input unit 11, the output unit 12, the storage unit 13, the pre-execution unit 14, and the application managing unit 15 of the information processing device 10 are illustrated. The pre-execution unit 14 includes a pre-execution detecting unit 14-1, a pre-execution search unit 14-2, and a pre-execution evaluation unit 14-3.

In the pre-execution processing described above, for example, when a user 30 inputs certain operation content through the input unit 11 while the user 30 is executing an application, the pre-execution detecting unit 14-1 detects the operation content and sets a target data processing type that corresponds to the detected operation content. The target data processing type obtained by the pre-execution detecting unit 14-1 is inputted to the pre-execution search unit 14-2.

The pre-execution search unit 14-2 refers to the storage unit 13 so as to obtain the application managing information, the cooperation history information, and so on that correspond to the target data processing type. The pre-execution search unit 14-2 then outputs information on the cooperation source application, the cooperation target application, the target data, and so on to the pre-execution evaluation unit 14-3.

The pre-execution evaluation unit 14-3 actually implements cooperation of the target data between the cooperation source application and the cooperation target application and obtains an evaluation result of the cooperation. This pre-execution evaluation processing is carried out as background processing (internal processing) while, for example, the user 30 is executing the cooperation source application.

In the example illustrated in FIG. 5, the pre-execution evaluation is carried out on a plurality of applications such as “application-1” and “application-2” stored in the storage unit 13, and the evaluation result thereof is given for each of the applications. An execution result obtained in this manner is stored in the storage unit 13 as inter-application cooperation information.

In the cooperation application execution processing, when the user 30 makes a request for cooperation through the input unit 11, the application managing unit 15 obtains the inter-application cooperation information from the storage unit 13. In addition, the application managing unit 15 presents information such as the inter-application cooperation information (e.g., processing cost, data) to the user 30 through the output unit 12. Through this, the user can 30 select and execute an appropriate application on the basis of the recommendation information of the inter-application cooperation information displayed by the output unit 12. The information on the executed application is stored in the storage unit 13 as the cooperation history information.

Pre-Execution Detecting Unit 14-1

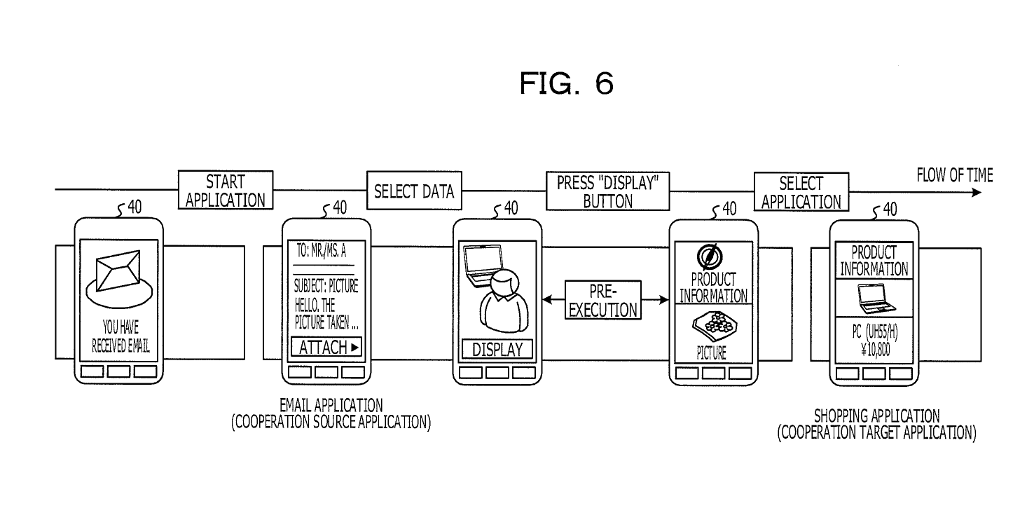

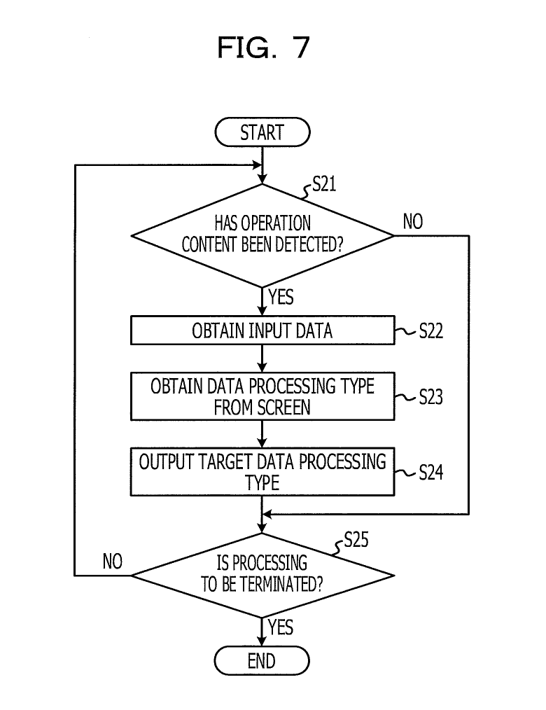

The pre-execution detecting unit 14-1 described above will now be described in further detail. FIG. 6 is a diagram for describing the content of the pre-execution detection. FIG. 7 is a flowchart illustrating an example of the pre-execution detection processing.

The pre-execution detecting unit 14-1 predicts a possibility of inter-application cooperation and determines a timing of pre-execution. For example, as illustrated in FIG. 6, in a communication terminal 40, which serves as an example of the information processing device 10, the pre-execution detecting unit 14-1 starts the pre-execution processing when the user carries out certain processing (e.g., browsing (displaying), editing, or the like) on a piece of data while the user is executing an email application, which is an example of the cooperation source application.

In the example illustrated in FIG. 6, as an example of the processing, the pre-execution detecting unit 14-1 starts the pre-execution processing when the user refers to an email received through the email application (cooperation source application) and the pre-execution detecting unit 14-1 detects that data attached to the email is selected. In addition, in the example illustrated in FIG. 6, when the user presses a “display” button in the application, candidate cooperation target applications obtained through the pre-execution are displayed. In the example illustrated in FIG. 6, a shopping application (product information) that corresponds to the attached data and a browsing application (picture) are displayed as recommended candidates for cooperation.

Here, when the user selects the shopping application (cooperation target application), the selected application is executed.

Note that, in the example described above, in the case where the information processing device 10 is the communication terminal 40, there is a single active application, and thus data to be searched through can be narrowed. In addition, even in the case where not only the entire data is selected but also part of the data is selected (e.g., when a word in a sentence is selected, or the like), the cooperation data is considered to be set, and the pre-execution can be started.

In the pre-execution detection processing illustrated as an example in FIG. 7, the pre-execution detecting unit 14-1 determines whether or not the pre-execution detecting unit 14-1 has detected content of a user operation on a currently executed application (S21). If the pre-execution detecting unit 14-1 has detected operation content (YES in S21), the pre-execution detecting unit 14-1 obtains input data (S22) and obtains a processing type from the screen (S23). In addition, the pre-execution detecting unit 14-1 outputs the target data processing type to the pre-execution search unit 14-2 (S24).

Here, if the pre-execution detecting unit 14-1, for example, has detected an event or the like other than the operation content after the processing in S24 or during the processing in S21 (NO in S21), the pre-execution detecting unit 14-1 determines whether or not to terminate the processing (S25). If the processing is not to be terminated (NO in S25), the processing returns to S21. Meanwhile, if the pre-execution detecting unit 14-1 determines to terminate the processing on the basis of an instruction or the like from the user through an application termination event or the like (YES in S25), the pre-execution detecting unit 14-1 terminates the cooperation application execution processing.

Pre-Execution Search Unit 14-2

The pre-execution search unit 14-2 described above will now be described in further detail. The pre-execution search unit 14-2 searches for a group of applications that can handle the cooperation data and determines the order in which these application are to be executed. In other words, the pre-execution search unit 14-2, for example, searches for (a group of) applications that match a given condition by using the data processing type to cooperate with, the data format, and so on obtained from the application managing information or the like stored in the storage unit 13.

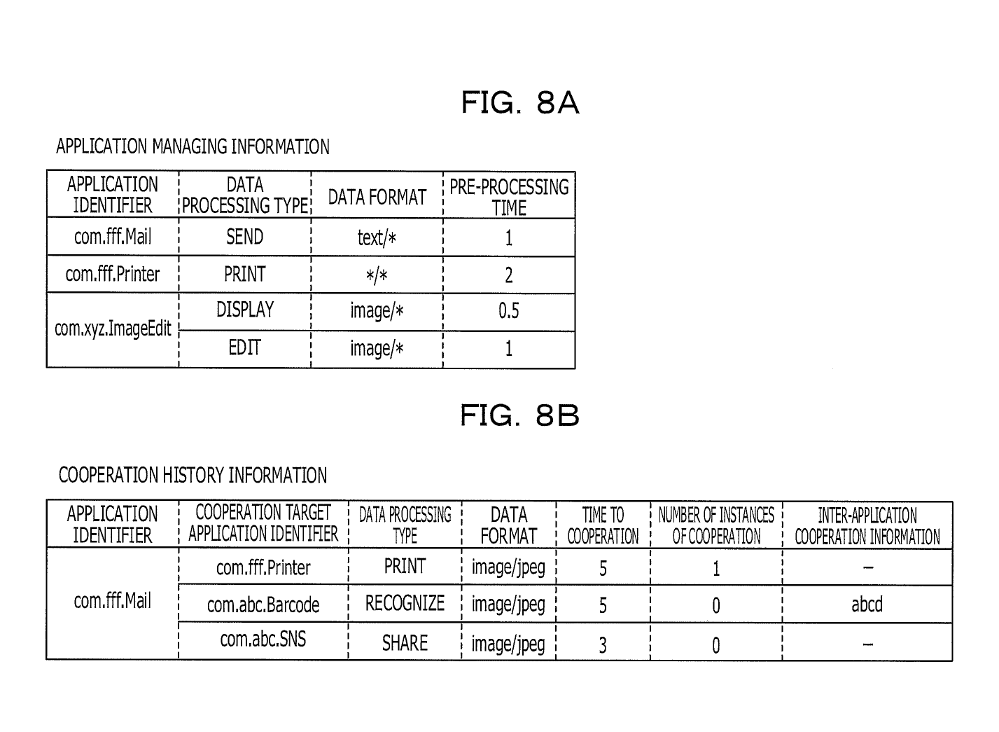

FIGS. 8A and 8B illustrate exemplary data stored in the storage unit. FIG. 8A illustrates an example of the application managing information, and FIG. 8B illustrates an example of the cooperation history information.

Items in the application managing information illustrated in FIG. 8A include, for example, “application identifier”, “data processing type”, “data format”, “pre-processing time”, and so on. The embodiment, however, is not limited thereto and may also include, for example, “the number of instances of cooperation”. The application identifier corresponds to information for uniquely identifying an application. The data processing type corresponds to information that indicates a type of processing (e.g., browsing (displaying), editing, and so on) in an application. The data format indicates a data format (e.g., MIME-type or the like is assumed) that can be handled in each processing. Note that, “*” in the data format indicates that any format may be accepted. For example, “image/*” indicates that any type of image data in, for example, a jpeg format, a bmp format, or a GIF format may be accepted. In addition, the pre-processing time corresponds to information on the time it takes for the pre-execution processing. Note that, as stated above, the application managing information may further include “the number of instances of cooperation” that indicates the number of instances of cooperation made in the past for each of the application identifiers.

In the embodiment, the pre-execution search unit 14-2 obtains the cooperation history information of the currently executed application from the storage unit 13 and determines the order in which the pre-execution is carried out on the group of applications that match a predetermined condition by using a predetermined system.

An example of the search condition in the pre-execution search unit 14-2 is such that, for example, the data processing type of the cooperation source application matches the data processing type in the application managing information and the data format of the cooperation source data matches the data format in the application managing information. The embodiment, however, is not limited thereto.

Meanwhile, items in the cooperation history information illustrated in FIG. 8B include, for example, “application identifier”, “cooperation target application identifier”, “data processing type”, “data format”, “time to cooperation”, “the number of instances of cooperation”, “inter-application cooperation information”, and so on, but the embodiment is not limited thereto.

The application identifier corresponds to information for uniquely identifying a cooperation source application, and the cooperation target application identifier corresponds to information for uniquely identifying an application that is in cooperation with an application having a given application identifier. The data processing type corresponds to information that indicates a type of processing (e.g., browsing (displaying), editing, and so on) in a cooperation target application. The data format indicates a data format handled in the processing. For example, “image/jpeg” indicates that cooperation has been made with image data of a jpeg format. The time to cooperation indicates the time it has taken from when the data is obtained until the inter-application cooperation. In addition, the number of instances of cooperation indicates the number of instances of cooperation made in the past between an application having a given application identifier and an application having a given cooperation target application identifier. In addition, the inter-application cooperation information corresponds to additional information on the inter-application cooperation.

Method for Determining Pre-Execution Order

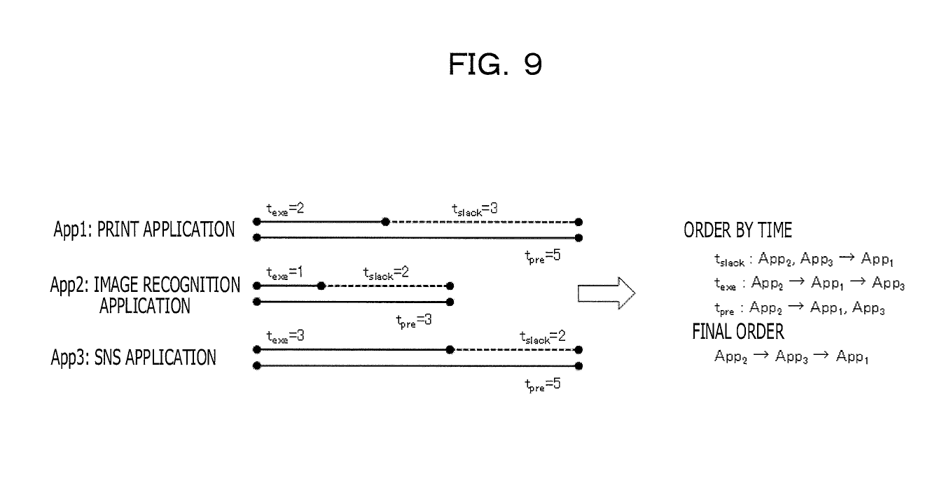

A method for determining the pre-execution order will now be described with reference to the drawings. FIG. 9 is a diagram for describing the method for determining the pre-execution order. In the example illustrated in FIG. 9, a cooperation slack time (t_{slack}) is calculated from a time to cooperation (tₚᵣₑ) and a pre-processing time (tₑₓₑ), and the pre-execution order is then determined on the basis of the calculated cooperation slack time.

The time to cooperation and the pre-processing time are defined in the cooperation source application and the cooperation target application. When the pre-execution processing and the cooperation processing are carried out, time information that is defined in advance is overwritten with the obtained time to cooperation and pre-processing time, or predetermined learning processing is carried out, which enables a time difference to be accommodated on a user-by-user basis.

For example, in the example illustrated in FIG. 9, in the case where processing such as detecting a network condition and user authentication is to be carried out, the pre-processing time (tₑₓₑ) decreases in the order of an SNS application (App₃), a print application (App₁), and an image recognition application (App₂). Meanwhile, the time to cooperation (tₚᵣₑ) is shorter for the image recognition application than for the print application or the SNS application according to the past statistics or the like. In such a case, the pre-execution is carried out in the order in which the cooperation slack time (t_{slack}) is shorter, or in other words, in the order of the image recognition application, the SNS application, and the print application. Note that although the image recognition application and the SNS application have the same cooperation slack time (t_{slack}) in the example illustrated in FIG. 9, the image recognition application having a shorter pre-processing time, for example, is given a priority. The method for giving a priority, however, is not limited thereto.

Improving Efficiency in Pre-Execution Processing

Improvement of efficiency in the pre-execution processing will now be described. In order to improve efficiency in the pre-execution processing, in the case where, for example, data cooperation has been carried out in the past using the same data, the processing cost and the post-processing data are reused without carrying out the pre-execution. Note that data is considered to be the same in a case where, for example, the data format of the cooperation data is the same as the data format included in the cooperation history information illustrated in FIG. 8B described above or the like. The embodiment, however, is not limited thereto. In addition, the cooperation using the same data refers to a case where the data processing type of the same data is the same as the data processing type in the cooperation history information illustrated in FIG. 8B described above. The embodiment, however, is not limited thereto. The use of the cooperation history information makes it possible to obtain a recommended candidate cooperation application while omitting the pre-execution processing.

In addition, in the embodiment, in the case where the data from the pre-execution is not to be reused, the pre-execution processing may be carried out each time without storing (caching) the cooperation history information. For example, in the case where the cooperation target action of image data is “edit”, the cooperation history information is not present, and thus the pre-execution is carried out. Here, the inter-application cooperation information in the cooperation history information is not updated after the pre-execution, and thus the data is not reused even at the time of cooperation thereafter. Meanwhile, in the case where the cooperation target action is “recognition”, there exists a data processing type that corresponds to the data processing type in the cooperation history information illustrated in FIG. 8B. Thus, the data format of the next cooperation data is compared with the data format in the cooperation history information, and if the data formats are the same, the pre-execution is considered to have been carried out. Then, the inter-application cooperation information is reused.

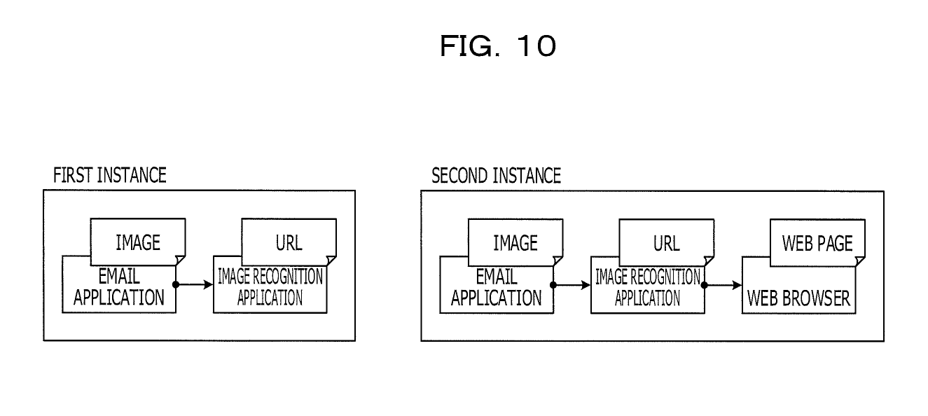

A candidate cooperation target application in the embodiment is, for example, capable of not only a single instance of data cooperation but also of data cooperation through another application. Here, FIG. 10 is a diagram for describing an example of obtaining a candidate application.

In the case where the inter-application cooperation information is present in the cooperation history information as illustrated in FIG. 8B, the data obtained after the processing of the application to cooperate with can, for example, be further searched through for inter-application cooperation information. Through this, the number of candidate cooperation target applications can be increased, and the candidate cooperation target applications can be presented hierarchically to the user.

For example, as illustrated in FIG. 10, when the user is browsing an image file in an email application, the image data is processed through the pre-execution processing of an image recognition application and converted into an encoded character string such as a uniform resource locator (URL). This character string is then stored in the inter-application cooperation information or the like of the cooperation history information as a pre-processing result.

Thereafter (second instance or later), if the user browses the same image file in the email application, a web browser that can cooperate with the previously generated URL can serve as a target of the pre-execution processing.

Pre-Execution Evaluation Unit 14-3

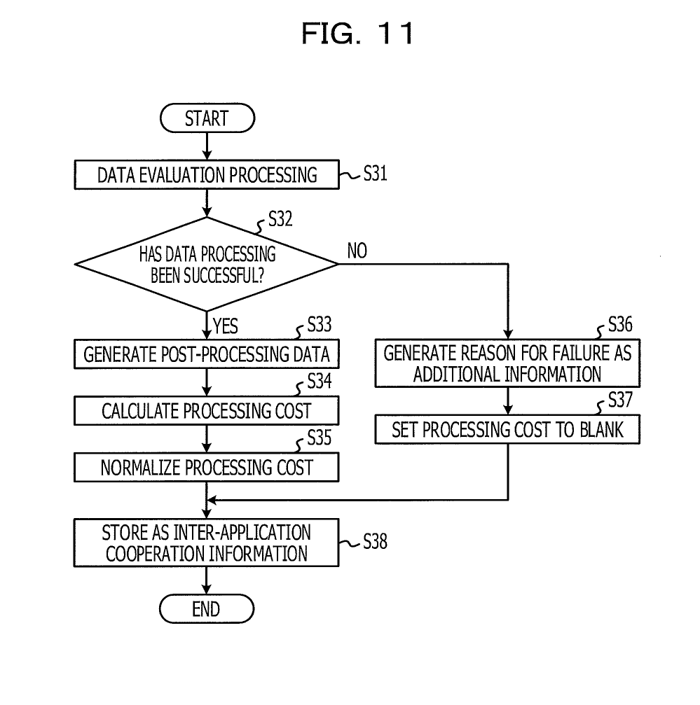

The pre-execution evaluation unit 14-3 described above will now be described in further detail. FIG. 11 is a flowchart illustrating an example of the pre-execution evaluation processing. In the pre-execution evaluation processing illustrated as an example in FIG. 11, the pre-execution evaluation unit 14-3 carries out predetermined data evaluation processing (S31) and then determines whether or not the predetermined data processing has been successful (S32). If the data processing has been successful (YES in S32), the pre-execution evaluation unit 14-3 generates post-processing data (S33), calculates a processing cost (S34), and normalizes the processing cost (S35). Note that, in the processing in S35, the processing cost is normalized, for example, in an integer within a range of 0 to 100. The embodiment, however, is not limited thereto, and the normalization may not be carried out.

Meanwhile, if the data processing has not been successful (NO in S32), the pre-execution evaluation unit 14-3 generates a reason for the processing failure or the like as additional information (S36) and sets the processing cost to none (blank) (S37).

The pre-execution evaluation unit 14-3 then stores, in the storage unit 13, the result obtained through the processing in S35 or S36 as the inter-application cooperation information (S38).

In the pre-execution evaluation processing described above, predetermined data processing is carried out in the cooperation target application. If the data processing is available, the processing content is converted into a score to serve as the processing cost, and if the data processing is not available, content for solution is generated and stored in the storage unit 13. The predetermined data processing refers, for example, to processing content or the like that is set in advance for each of the data processing types described above, but the embodiment is not limited thereto. When converting the data processing content into a score, the processing within the application is called for by using the cooperation data so as to confirm that the data is to be processed properly. In addition, the application returns the post-processing data and a plurality of processing costs to the system as the results of the processing.

In addition, in the embodiment, the order of the applications may be set by using the processing cost items specified by the user. If applications have the same processing cost, the order of the applications may be set by using, for example, the number of instances of cooperation in the past, but the embodiment is not limited thereto. In addition, in the embodiment, candidate applications are displayed along with the data obtained through the pre-execution processing that has been carried out in each of the applications, which enables the user to easily select an appropriate application.

As described above, in the pre-execution processing, a plurality of processing costs in actual processing that is based on the cooperation data can be calculated, and the calculated costs can serve as the reference for the user to make a selection.

If Pre-Execution Processing Fails

Here, if the pre-processing fails in the processing in S32 described above, the processing cost becomes none. In this case, as the processing in S36, the application may return information indicating what kind of modifications made to the processing data enables cooperation. This makes it possible to prompt for a data correction before the user starts the cooperation target application.

In addition, an evaluation cost calculated by the pre-execution evaluation unit 14-3 is, for example, stored in the storage unit 13 as the inter-application cooperation information in the cooperation history information illustrated in FIG. 8B and is used to recommend a candidate application in the end.

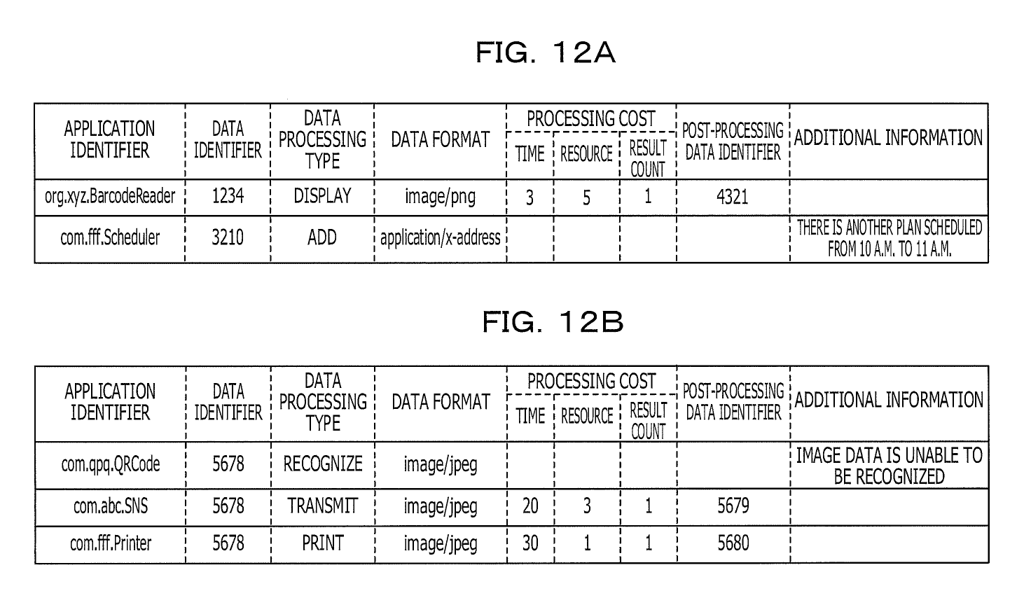

Here, FIGS. 12A and 12B illustrate examples of the inter-application cooperation information. The inter-application cooperation information illustrated in FIGS. 12A and 12B is also an example of a list of evaluation results. The inter-application cooperation information illustrated in FIGS. 12A and 12B is exemplary data to be stored in the storage unit 13. Items include, for example, “application identifier”, “data identifier”, “data processing type”, “data format”, “processing cost (time, resource, result count)”, “post-processing data identifier”, “additional information”, and so on, but the embodiment is not limited thereto. For example, “application identifier”, “data processing type”, “data format” and so on included in the cooperation history information illustrated in FIG. 8B described above can be omitted from the inter-application cooperation information. In addition, the inter-application cooperation information may not be included in the cooperation history information and may be stored in the storage unit 13 as a separated piece of data.

The data identifier corresponds to information for identifying cooperation data or the like. The data format indicates a data format of cooperation data. The processing cost corresponds to a processing cost calculated by the pre-execution evaluation unit 14-3. The post-processing data identifier corresponds to information for identifying data generated through the pre-processing. The additional information indicates content for solution or the like obtained when the processing fails.

In the pre-execution evaluation processing, the result of the pre-execution carried out in each of the applications is stored in the storage unit 13 as the inter-application cooperation information as soon as the execution ends. Here, in the example illustrated in FIG. 12A, in the case of a scheduler application (the data processing type indicates “add”), since another plan has been scheduled during the time period, the processing cost is blank, and error information is stored under the additional information. Such error information indicates, for example, “there is another plan scheduled from 10 a.m. to 11 p.m.”, or the like, but the embodiment is not limited thereto.

Meanwhile, in the example illustrated in FIG. 12B, in the case of the image recognition application (the data processing type indicates “recognize”), since no code image is present within the image data which can be recognized, the processing cost is left blank, and error information is stored under the additional information. Such error information indicates, for example, “the image data is unable to be recognized”, or the like, but the embodiment is not limited thereto.

Examples of Processing Cost

The processing costs illustrated in FIGS. 12A and 12B described above are calculated, for example, from the time, the resource, and the result count. The embodiment, however, is not limited thereto, and the processing cost may be calculated, for example, by using at least one piece of information among the items listed above or by using another item.

The time corresponds to a predictive value of the actual time it takes for the processing and can be calculated, for example, from “initial processing time+unit processing time×data size” or the like, but the embodiment is not limited thereto. The resource corresponds to, for example, an access resource count. The access resource count indicates the number of resources to be used when processing the cooperation data. The resources include, for example, a network, a file, positional information, a contact address, a calendar, and so on, but the embodiment is not limited thereto. The result count corresponds to the number of results obtained when the cooperation data is processed.

The processing cost and the user selection index described above will now be described. The selection indexes include, for example, “safety”, “promptness”, “accuracy”, “variety”, and so on. The embodiment, however, is not limited thereto, and, for example, at least one of the indexes mentioned above may be included.

The safety can be obtained through the access resource count described above. A smaller access resource count indicates that the application is not using information within the terminal or external (e.g., cloud services or the like) information, and such a state can thus be said to be safe. The promptness can be obtained through the time (processing time) and the result count described above. Less time and a smaller result count indicate that the time it takes for the target processing to end is shorter. The accuracy can be obtained through the result count and the access resource count. A greater access resource count indicates that the original data is larger, and a smaller result count indicates that the search accuracy has carefully been examined and is thus accurate.

The variety can be obtained through the result count and the access resource count. A greater access resource count indicates that the number of data is larger, and a greater result count indicates a greater variety.

For example, in the SNS application or the like, resources such as the network connection and the address book and the calendar in the information processing device 10 are used, and thus the resource count is 3. Meanwhile, in the print application, only the resource of the network connection is used, and thus the resource count is 1.

Specific Examples of Pre-Execution Evaluation

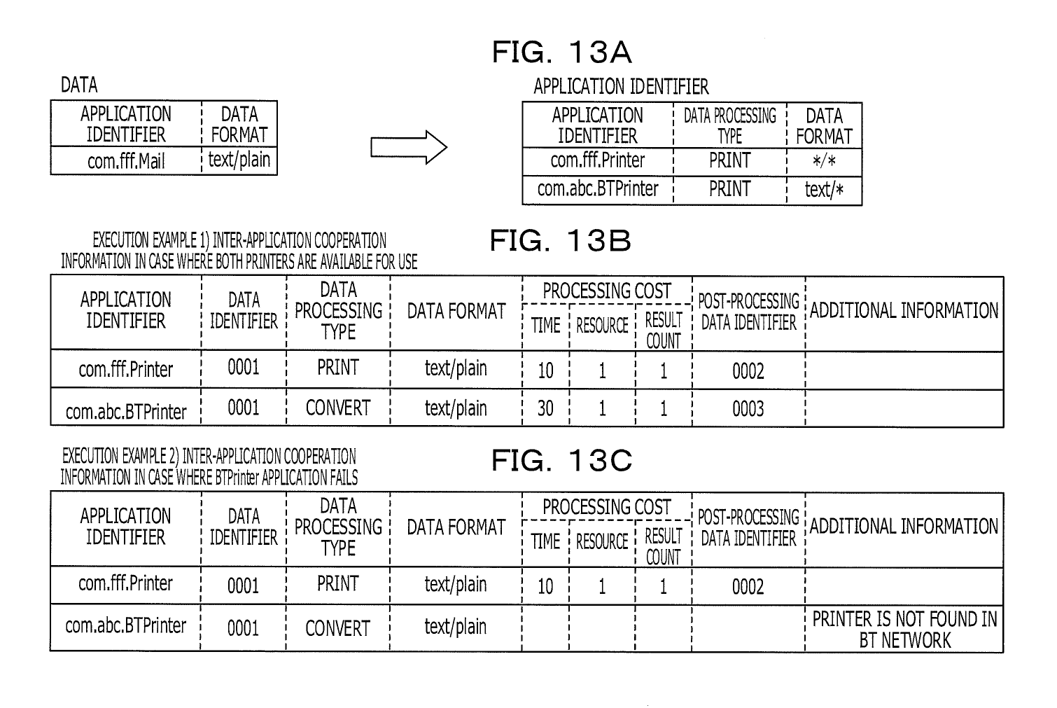

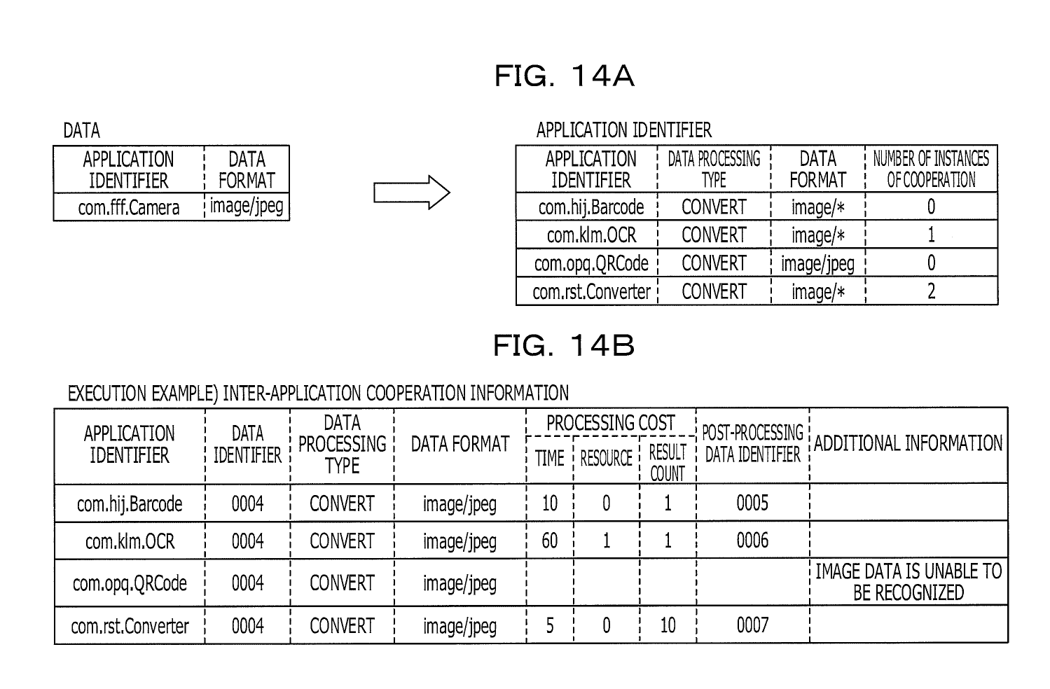

Specific examples of the pre-execution evaluation will now be described with reference to the drawings. FIGS. 13A, 13B, 13C, 14A, and 14B illustrate specific examples of the pre-execution evaluation. The specific example illustrated in FIGS. 13A, 13B, and 13C corresponds to an example of printing a received email, and the specific example illustrated in FIGS. 14A and 14B correspond to an example of carrying out image recognition on a picture taken by an image capturing unit such as a camera.

In the specific example illustrated in FIG. 13A, the application managing information indicates that a plurality of applications that are capable of printing the inputted target data (application identifier “com.fff.Mail”, data format “text/plain”) are present. Thus, in the embodiment, the pre-execution is carried out on each of the applications and the obtained result is evaluated.

Here, in an execution example 1 illustrated in FIG. 13B, inter-application cooperation information of a case where both printers (“com.fff.Printer”, “com.abc.BTPrinter”) are available for use is indicated, and in an execution example 2 illustrated in FIG. 13C, inter-application cooperation information of a case where the “com.abc.BTPrinter” application fails. The times in the execution example 1 and the execution example 2 indicate processing times calculated by the respective applications, and the number of used resources is indicated as being 1 since the network is used as a resource. In addition, the post-processing data identifier is a piece of data generated through the pre-execution and is used when recommending an application.

In the execution example 2, since the pre-processing has failed in “com.abc.BTPrinter”, each space under the processing cost is left blank. In addition, a cause for the error in the “com.abc.BTPrinter” application is recorded (e.g., “a printer is not found in a BT network” or the like) under the additional information.

Meanwhile, in the specific example illustrated in FIGS. 14A and 14B, there is a case where a plurality of applications are present that identify the data processing type of the inputted data (application identifier “com.fff.Camera”, data format “image/jpeg”) to be identical (“convert” in the example illustrated in FIG. 14A) while the content of cooperation differs for one another. In such a case, the pre-execution processing is carried out on each of the applications, and the processing cost is calculated to evaluate each of the applications.

In addition, in the embodiment, if multiple applications have the same processing cost in the inter-application cooperation information, the order can be determined by using the number of instances of cooperation or the like included in the inter-application managing information illustrated in FIG. 14A. For example, the order can be set in the order of a larger number of instances of cooperation, but the embodiment is not limited thereto. In the embodiment, the order of the recommended applications can be switched in accordance with the items under the processing cost.

### Exemplary Screens

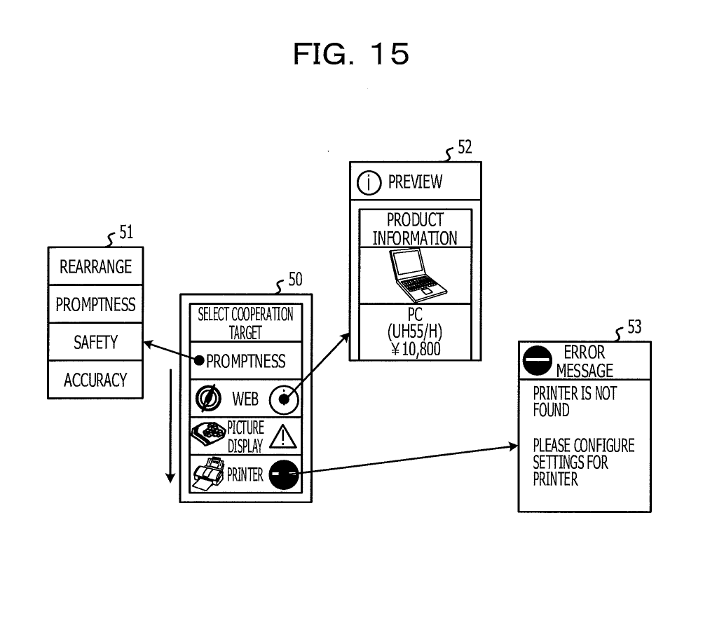

Exemplary screens to be generated by the screen generation unit 17 will now be described with reference to the drawings. FIGS. 15, 16A, 16B, 17A, 17B, and 17C illustrate exemplary screens.

The screen generation unit 17 receives a list of inter-application cooperation information or the like from the application managing unit 15 and generates a screen that prompts the user to select an application. The generated screen is displayed by the output unit 12.

In addition, the screen generation unit 17 can rearrange the applications on the basis of the selection index specified by the user. The screen generation unit 17 generates a screen for each application to indicate whether each of the applications can be executed or is unable to be executed. If an application can be executed, the screen generation unit 17 may generate a screen for displaying data obtained through the pre-execution of that application. Meanwhile, if an application is unable to be executed, the screen generation unit 17 may generate a screen for displaying a reason why the application is unable to be executed.

In addition, the screen generation unit 17 may generate and display an icon for an application that is being subjected to the pre-execution or that is to be subjected to the pre-execution to indicate that the application has not been processed and may display an updated list as soon as the execution ends. In the case where cooperation is actually made, the application managing unit 15, for example, updates the number of instances of cooperation, the time to cooperation, and so on in the cooperation history information.

In the example illustrated in FIG. 15, the candidate applications are displayed in a screen 50 of the output unit 12 in the order of the processing costs. Here, when a “web” application is selected in the screen 50, cooperation with the selected “web” application is started, and the post-processing data generated through the pre-execution is displayed as in a screen 52. Meanwhile, when a “picture display” application is selected in the screen 50, display is not carried out since the pre-execution processing has not finished. In this case, display may be carried out to indicate that the pre-execution has not finished. When a “printer” application is selected in the screen 50, since the processing cost to be obtained through the pre-execution is not present and the cooperation is unable to be made, an error message indicating a reason why the cooperation is unable to be made is displayed as in a screen 53. Note that, in the example illustrated in FIG. 15, an error message stating “The printer is not found. Please configure the settings for the printer.” is displayed, but the displayed content is not limited thereto.

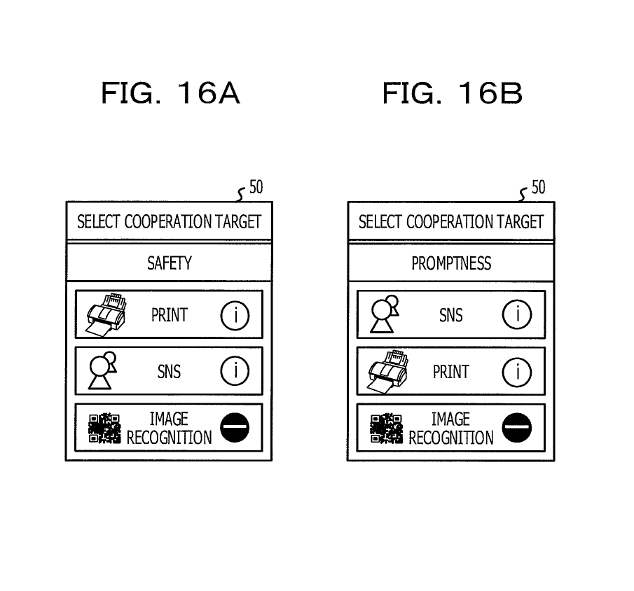

In addition, the order of the cooperation targets to be selected from which are displayed in the screen 50 can be modified in accordance with the selection index 51 set in advance as illustrated in FIG. 15. For example, as illustrated in FIG. 16A, when the user selects the “safety” index, the “print” application having a smaller access resource count is displayed at the top in the screen 50 followed by the “SNS” application and the “image recognition” application in that order. Meanwhile, as illustrated in FIG. 16B, when the user selects the “promptness” index, the “SNS” application having a shorter processing time and a smaller result count is displayed at the top in the screen 50 followed by the “print” application and the “image recognition” application in that order.

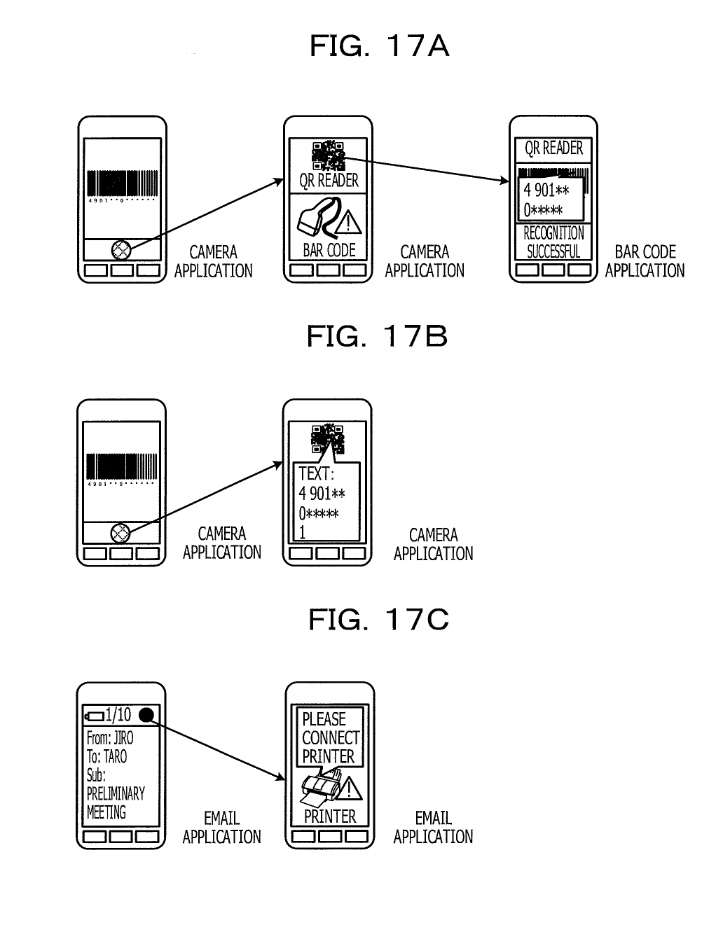

In the embodiment, when recommending an application that can cooperate with the data being processed, data is processed in advance in the cooperation target application, and thus, as illustrated in FIG. 17A, applications to subsequently cooperate with can be displayed in the order of degree of success of the pre-execution. In the example illustrated in FIG. 17A, a bar code application that reads a QR code (registered trademark), a bar code, or the like is executed in cooperation with an image captured by a camera application. Through this, the user can select an appropriate application that succeeds in the processing.

In addition, in the embodiment, as illustrated in FIG. 17B, data on the result from successful pre-execution can be displayed. In the example illustrated in FIG. 17B, the bar code application has been pre-executed on the image captured by the camera application, and the result obtained by reading the image is displayed. Through this, the user can predict the processing content of the application and can select an appropriate application with ease.

In addition, in the embodiment, as illustrated in FIG. 17C, if the pre-execution processing fails, the reason for the failure or a solution can be displayed. In the example illustrated in FIG. 17C, in the case where the print application has been unable to be executed from the email application, “please connect a printer” is displayed as a solution. Through this, the user can understand a problem prior to starting an application and can make a correction accordingly.

According to the embodiment described thus far, the inter-application cooperation can be carried out appropriately. In addition, according to the embodiment, the operation cost of the user in the inter-application cooperation can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A cooperation method executed by a computer, the cooperation method comprising:
extracting, based on a first application that is executed, kind of data being processed by the first application, and history information, at least one second application that was executed next to the first application before;
executing processing the data using the at least one second application;
evaluating a result of the processing by the at least one second application by a processor; and
suggesting a second application, among the at least one second application, based on a result of the evaluating.

2. The cooperation method according to claim 1, further comprising:
detecting content of a user operation on the data; and
searching for the at least one second application corresponding to the content of the operation.

3. The cooperation method according to claim 1, wherein the processing that uses the data is carried out by the at least one second application when predetermined processing is started on the data or when a predetermined portion of the data is selected by the first application.

4. The cooperation method according to claim 2, wherein the result of the processing is evaluated on the basis of a processing cost by each of the at least one second application on.

5. The cooperation method according to claim 4,
wherein the at least one second application includes a plurality of second application, and
the cooperation method further comprises:
determining a display order of the plurality of second application on the basis of the processing cost; and
displaying a screen for selecting the plurality of second application on the basis of the display order.

6. The cooperation method according to claim 4, wherein the processing cost is at least one of a time, a resource, and a result count obtained when the processing that uses the data is carried out on each of the at least one second application.

7. An image processing device comprising:
a memory; and
a processor coupled to the memory and configured to:
extract, based on a first application that is executed, kind of data being processed by the first application, and history information, at least one second application that was executed next to the first application before,
execute processing the data using the at least one second application,
evaluate a result of the processing by the at least one second application, and
suggest a second application, among the at least one second application, based on a result of an evaluating process.

8. The image processing device according to claim 7, wherein the processor is further configured to:
detect content of a user operation on the data, and
search for the at least one second application corresponding to the content of the operation.

9. The image processing device according to claim 7, wherein the processing that uses the data is carried out by the at least one second application when predetermined processing is started on the data or when a predetermined portion of the data is selected by the first application.

10. The image processing device according to claim 8, wherein the result of the processing is evaluated on the basis of a processing cost by each of the at least one second application.

11. The image processing device according to claim 10,
wherein the at least one second application includes a plurality of second application, and
the processor is further configured to determine a display order of the plurality of second application on the basis of the processing cost, and display a screen for selecting the plurality of second application on the basis of the display order.

12. The image processing device according to claim 10, wherein the processing cost is at least one of a time, a resource, and a result count obtained when the processing that uses the data is carried out on each of the at least one second application.

13. A non-transitory computer readable recording medium storing a program for causing a computer to execute a process, the process comprising:
extracting, based on a first application that is executed, kind of data being processed by the first application, and history information, at least one second application that was executed next to the first application before;
executing processing the data using the at least one second application;
evaluating a result of the processing by the at least one second application; and
suggesting a second application, among the at least one second application, based on a result of the evaluating.
